(19) United States
(12) Patent Application Publication
(10) Pub. No.: US 2012/0278407 A1
(43) Pub. Date: Nov. 1, 2012

(54) AUTOMATIC UPLOADING OF ATTACHMENTS TO A SHARED LOCATION

(75) Inventors: Joshua Adam Meisels, Seattle, WA (US); Daniel Paul Costenaro, Bellevue, WA (US); Jedidiah Brown, Seattle, WA (US)

(73) Assignee: MICROSOFT CORPORATION, Redmond, WA (US)

(21) Appl. No.: 13/096,936

(22) Filed: Apr. 28, 2011

(51) Int. Cl. G06F 15/16

(52) U.S. Cl. 709/206

(57) ABSTRACT

Electronic messages are examined before they are sent to determine any attachments to the message. One or more of the attachments are automatically uploaded to a shared location that is accessible to the recipients of the message. A link replaces each attachment that was uploaded to the shared location. Permissions are automatically set at the shared location for each of the recipients of the message.

### BACKGROUND

Users routinely send attachments using electronic messages. When users send files that are attached to an electronic message, they create multiple copies of a given file. Not only does a copy of the attachment exist in each user's mailbox, the attachment is often stored in other locations as well.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Electronic messages are examined before they are sent to determine any attachments to the message. One or more of the attachments are automatically uploaded to a shared location that is accessible to the recipients of the message. A link replaces each attachment that was uploaded to the shared location. Permissions are automatically set at the shared location for each of the recipients of the message.

### BRIEF DESCRIPTION OF THE DRAWINGS

FIG. 1 illustrates an exemplary computing environment;

FIG. 2 shows a system for automatically uploading attachments to a shared location and replacing the uploaded attachment with a link within the message;

FIG. 3 shows displays of an electronic message before and after automatic uploading of attachments;

FIG. 4 illustrates a process for automatically uploading attachments to a shared location; and

FIG. 5 shows a process for automatically downloading content that is associated with a received message that includes a link to an uploaded attachment.

### DETAILED DESCRIPTION

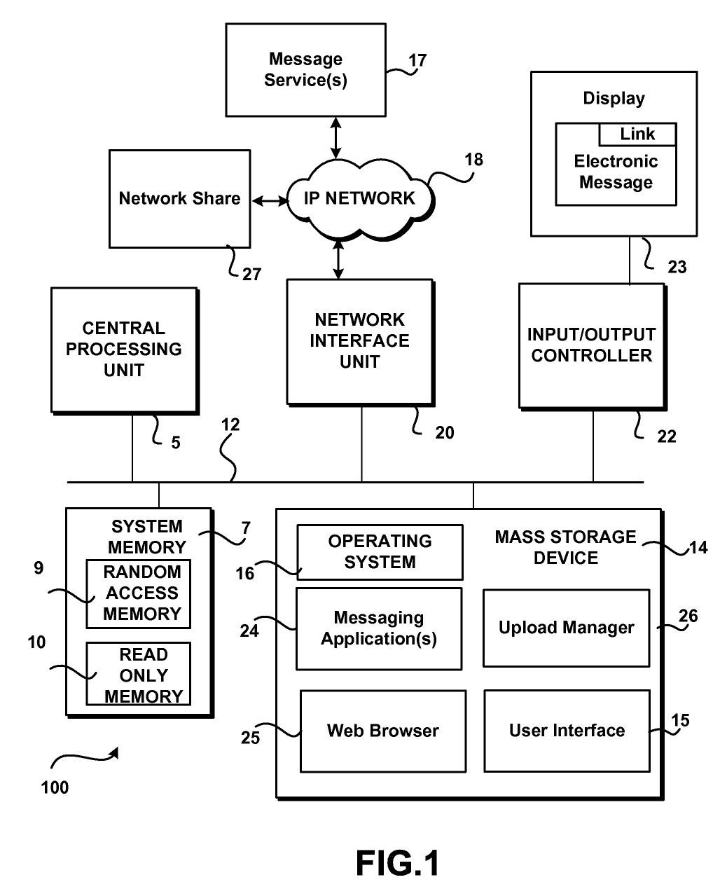

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a mobile computing device (e.g. phone, tablet, net book, laptop), server, a desktop, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, messaging application(s) 24, Web Browser 25, and upload manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to a display screen 23, a printer, or other type of output device.

As mentioned briefly above, a number of program modules and data files may be stored in the mass storage device 14 and RAM 9 of the computer 100, including an operating system 16 suitable for controlling the operation of a computer, such as the WINDOWS PHONE 7®, WINDOWS 7®, or WINDOWS SERVER® operating system from MICROSOFT CORPORATION of Redmond, Wash. The mass storage device 14 and RAM 9 may also store one or more program modules. In particular, the mass storage device 14 and the RAM 9 may store one or more application programs, including one or more messaging application(s) 24 and Web browser 25.

A user interface 15 is used by a user to interact with applications and documents. Messaging application(s) 24 may be one or more different messaging applications. For example, computer 100 may include an email application, an Instant Messaging (IM) application, an SMS, MMS application, a real-time information network (e.g. Twitter® interface), a social networking application, and the like. According to an embodiment, messaging application 24 is an email application, such as MICROSOFT OUTLOOK®. The messaging application(s) may be client based and/or web based. For example, a network based message service 17 may be used, such as: MICROSOFT WINDOWS LIVE or some other network based email and messaging service.

Network share 27 is configured to store content (e.g. documents, spreadsheet, Web content, and the like) that are accessible to one or more users through IP network 18. For example, network share 27 may store content that is accessible by users located at one or more locations.

Upload manager 26 is configured to automatically upload attachments and to replace them with a link to the shared location where the attachments were uploaded. The term “link” refers to an address that represents a location of content. For example, a link may be in the form of a Uniform Resource Locator (URL) that specifies a network location of where the attachment/content is stored. Clicking the link generally retrieves the content that is pointed to by the link. Upload manager 26 may be located externally from an application, e.g. messaging application 24, as shown or may be a part of an application. Further, all/some of the functionality provided by upload manager 26 may be located internally/externally from a messaging application.

Upload manager 26 automatically determines the attachments to an electronic message before the message is sent. One or more of the attachments are uploaded by upload manager 26 to a shared location that is accessible to the recipients of the message. According to an embodiment, each attachment of the message is uploaded to a shared location. A link replaces each attachment within the message that was uploaded to the shared location. Upload manager 26 automatically sets the permissions of the attachment(s) at the shared location. The attachments may be many different types of content, such as word processing documents, spreadsheets, slides, pictures, videos, website content and the like. When the message is delivered to the recipient, the attachment that is addressed by the link may be automatically downloaded and included with the display of the link or in place of the link within the message. More details regarding the upload manager are disclosed below.

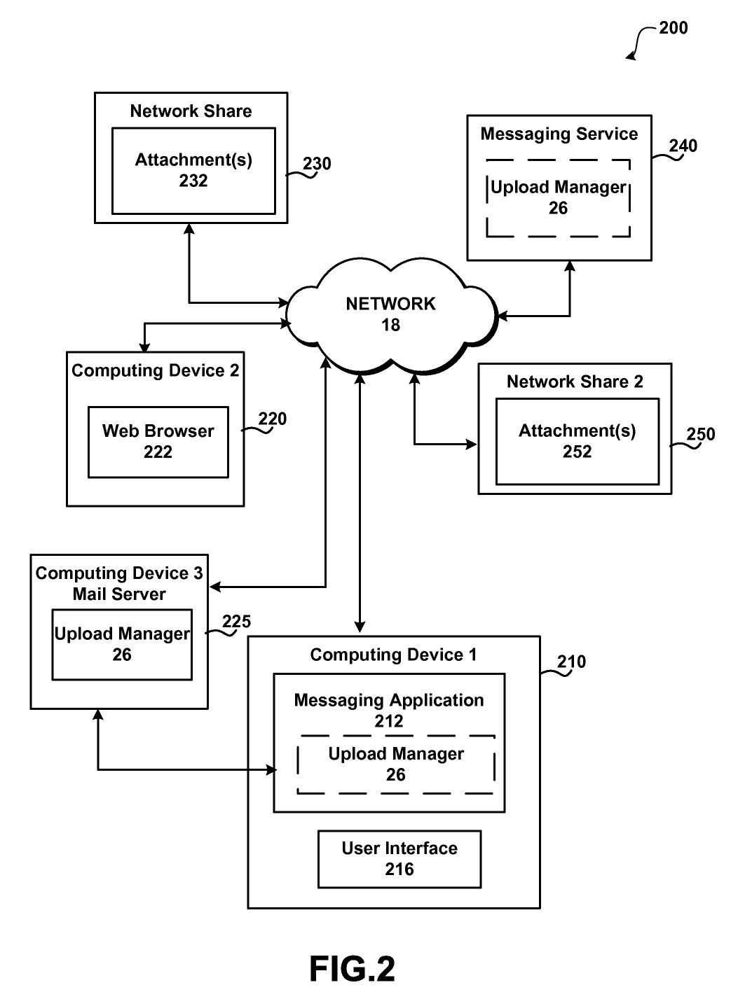

FIG. 2 shows a system for automatically uploading attachments to a shared location and replacing the uploaded attachment with a link within the message. As illustrated, system 200 includes computing device 1 (210), computing device 2 (220), computing device 3 (225), network shares 230 and 250 and messaging service 240.

The computing devices may be any type of computing device that is configured to perform the operations relating to sending and receiving electronic messages that include attachments and links to content. For example, some of the computing devices may be: mobile computing devices (e.g. cellular phones, tablets, smart phones, laptops, and the like); desktop computing devices and servers. Some computing devices may be arranged to provide an online service (e.g. messaging service 240 that is configured for sending and receiving electronic messages), some may be arranged as data shares, some may be arranged in local networks, some may be arranged in networks accessible through the Internet, and the like.

The computing devices are coupled through network 18. Network 18 may be many different types of networks. For example, network 18 may be an IP network, a carrier network for cellular communications, and the like. Generally, network 18 is used to transmit data between computing devices, such as computing device 1, computing device 2, computing device 3, network share 230, network share 250 and messaging service 240.

Computing device 1 includes messaging application 212 and user interface 216. As illustrated, computing device 1 is used by a user to interact with electronic messages, content in a network share (e.g. attachment 232, 252) and the like.

User interface (UI) 216 is used to interact with an application and content, such as messaging application 212 and attachment(s) 232, 252. One or more user interfaces of one or more types may be used to interact with the content. For example, UI 216 may include the use of a context menu, a menu within a menu bar, a menu item selected from a ribbon user interface, a graphical menu, and the like. Generally, UI 216 is configured such that a user may easily interact with content and electronic messages. For example, a user may simply select an option within UI 216 to attach a file to a message. UI 216 may also be used to set permissions that are used for the attachment at the shared location and to access the attachment and/or link to the attachment.

Upon receipt of the message, the recipient of the message may access the uploaded attachment using the link within the received message. According to an embodiment, the attachment is downloaded to the recipient's device automatically. The link to the attachment may/may not be removed from the message when the attachment is downloaded. For example, upon receipt of the message including the link to the attachment, upload manager 26 may automatically download the attachment, remove the link from the message and attach the downloaded attachment to the message. In this way, the recipient receives the message as if the attachment was delivered with the message.

Messaging application 212 may be a client based application, such as an email application, an Instant Messaging Application, a social media application, and the like. Generally, messaging application 212 is used to send and receive electronic messages of one or more types. A network based messaging service 240 may be used in addition to messaging application 212 or instead of one or more of the different messaging applications. For example, a web interface may be used to access messaging service 240.

Messaging service 240 may be used to process electronic messages between one or more computing devices, such as computing device 1 and computing device 2. Messaging service 240 may be configured to process different message types, such as SMS, MMS, email, messages for social networks and the like. Messaging service 240 may be configured with the functionality of upload manager 26 and one or more message types may be used to communicate the electronic messages including links to the uploaded attachment(s).

Computing device 2 includes one or more applications, such as a web browser (222) that may be configured to access a messaging service, such as a web based email service and to interact with content. For example, a web browser may be used to access messaging service 240 and create an electronic message including one or more attachments.

One or more network shares (e.g. network share 230, network share 250) may be used to store content. The content may be any type of content that is linked/attached within a message, such as word processing documents, spreadsheets, slides, website content and the like Network share 230 is accessible by the computing devices that interact with the content. The network share may be associated with an online service that supports online access/interaction with content. The network share(s) may be associated with one or more online services. For example, different network shares may be associated with different types of attachments (e.g. a network share for a video service, picture service, document service, and the like.). A user may designate one or more network shares as a designated shared location. According to an embodiment, when an attachment is automatically uploaded, the attachment is uploaded to one or more of the designated shared locations. For example, an attachment may be uploaded to a designated shared location of a first recipient and a different designated shared location of a second recipient.

Computing device 3 (225) is configured as a mail server. For example, messaging application 212 on computing device 1 may be used to create a message that includes an attachment that is to be sent to one or more recipients. When the user sends the message, computing device 3 may be configured to perform various mail processing actions and to deliver the message to the one or more recipients. As illustrated, computing device 3 includes functionality of upload manager 26. According to an embodiment, computing device 3 (mail server) determines the files that are attached to a message created using a client computing device, removes the attachments and uploads and permissions them at a shared location after a user has selected the send option.

Upload manager 26 is configured to detect the attachments to an electronic message and to automatically upload the attachments to a shared location, such as network share 230 and/or network share 2 (250). The attachments may be to any type of content, such as word processing documents, spreadsheets, slides, pictures, videos, website content and the like. Each attachment that is uploaded to a shared location is replaced with a link to the attachment at the shared location within the message. According to an embodiment, the link(s) are placed within an attachment area of the electronic message such that when a user receives the message the links to the uploaded attachments are easily locatable. A single link may also be used to address all of the attachments that were uploaded to the shared location (e.g. the link may point to a folder containing the uploaded attachments). The attachments may be uploaded before the message is sent and/or after the message is sent. According to an embodiment, the attachments are uploaded when a mail server processes the message for delivery.

Upload manager 26 is configured to automatically permission the uploaded attachments at the network share(s). The permissions for each of the attachments/recipients may be set the same/differently. For example, read/write permissions may be set for each of the recipients of the message. The permissions may also be set on other security criteria. For example, upload manager 26 may be configured to restrict access to an attachment when a recipient of a message is outside of a security group (e.g. the recipient is not a part of the same organization/group/team as the sender). Different permissions may be set. For example, a recipient outside of a trusted security group may be restricted from accessing the attachment, the recipient may have read permissions but not write permissions, and the like. Recipients in different groups may have different permissions to the attachments. Senders may also be restricted from sending/forwarding a message to a recipient that is determined to be unauthorized. The security settings may be set by a user (e.g. an administrator).

According to an embodiment, any attachments that were uploaded are automatically downloaded and included within the attachment area before the user receiving the message views the message. For example, upon receipt of the message, the linked attachment may be automatically downloaded and included with the message. All/some of the linked content may be automatically downloaded. The links to the attachments may/may not be removed from the message after the attachments are downloaded.

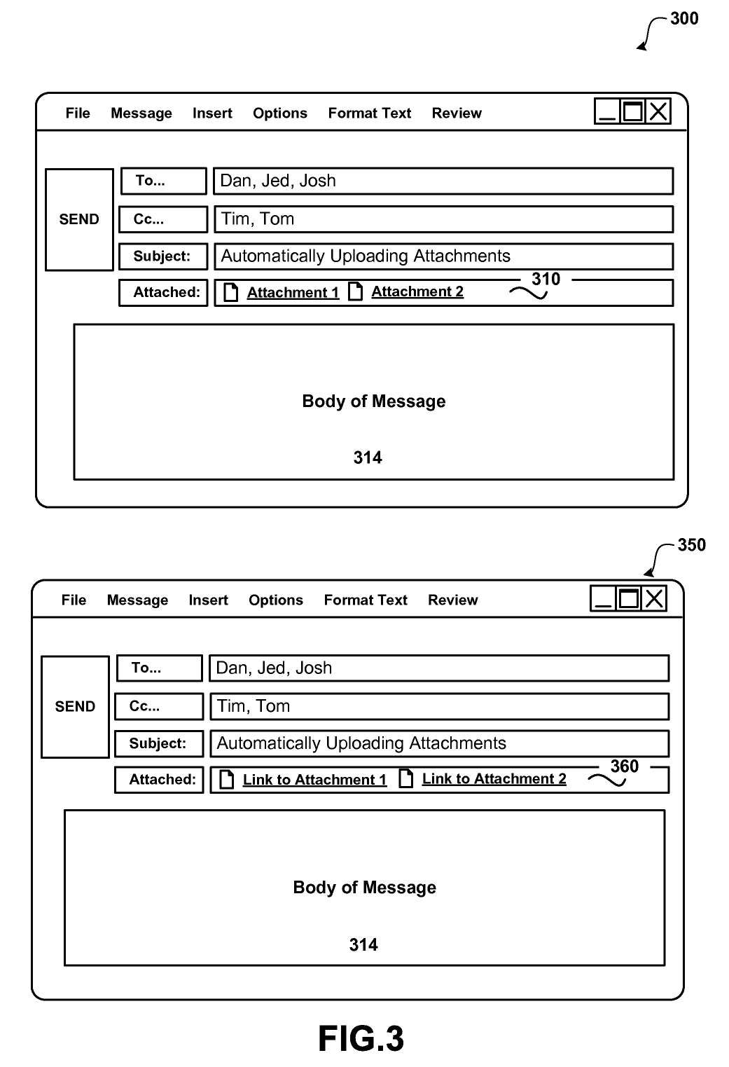

FIG. 3 shows displays of an electronic message before and after automatic uploading of attachments. As illustrated, message 300 and message 350 comprise a To: field, a Cc: field, a Subject field:, an Attached field; and body of the message 314. More or fewer fields may be included with the electronic message.

The electronic message may be created/accessed a number of ways. For example, a web browser may access an electronic mail service, an email application on a computing device may be configured to send/receive emails from one or more different services, and the like.

When electronic message is created, one or more files may be attached to the message (e.g. attachment 1 and attachment 2 (310)). The attachments may be to any type of content, such as pictures, videos, word processing documents, spreadsheets, slides, websites and the like. Generally, the attachment may be to any type of content that is accessible by a computing device.

Message 350 shows message 310 after the attachments have been removed and uploaded and replaced with links to the uploaded attachments (Link to Attachment 1 and Link to Attachment 2 (360)). According to an embodiment, the link to the uploaded attachments (260) is located within an attachment area of the message such that the user does not have to search for the linked content within the body of the electronic message.

The attachment area may be located within many different areas of the display. Generally, the attachment area is located such that the display of the attached area remains visible even though the body of the message is scrolled to change the view of the message. A graphical indicator, such as an icon, may be displayed within the attachment area near the link to provide additional information relating to the attachment. The graphical indicator may be selected to indicate a type of the content and/or other characteristics relating to the linked content. For example, a document icon may be used to show the content is a document, a web icon may be used for web content, a spreadsheet icon may be used for spreadsheets, a picture icon may be used for pictures, a message icon may be used for messages, an online service icon may be used to show where the attachment has been uploaded (e.g. a video service icon to indicate that the attachment has been uploaded to video service 1, a picture service icon . . . ) and the like.

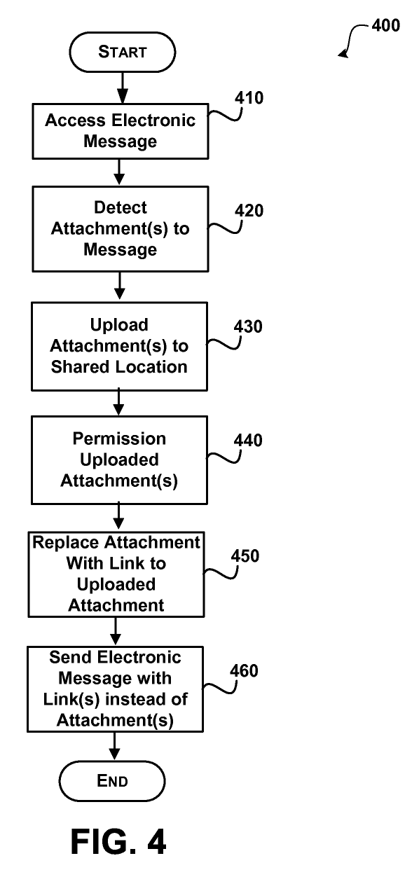

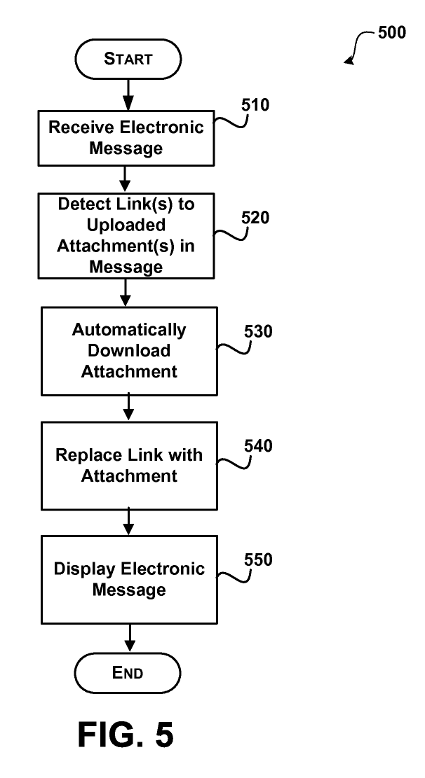

FIGS. 4 and 5 shows an illustrative process for automatically uploading attachments to a shared location and automatically downloading attachments in a received message. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 4 illustrates a process for automatically uploading attachments to a shared location.

After a start block, process 400 moves to operation 410, where the electronic message is accessed. The electronic message may be any electronic message that includes the ability to attach content. According to an embodiment, the electronic messages are email messages. Other messages may also be used attachments, such as SMS, MMS, Instant Messages, social network messages, and the like.

Flowing to operation 420, any attachments that are associated with the electronic message are detected. According to an embodiment, the detection occurs after a user has indicated to send the message. The detection may occur at other times (e.g. when the file is attached to the message).

Moving to operation 430, the attachments are uploaded to one or more shared locations. The attachments may be uploaded to shared locations based on different criteria. For example, a shared location may be selected based on a type of the attachment (e.g. video attachments to a shared location that hosts videos, picture attachments to a shared location that hosts pictures, documents to a shared location that hosts documents, and the like.) A shared location may also be selected based on shared locations that are selected by the sender and/or one or more of the recipients. For example, each recipient may have configured preferences indicating a desired shared location. The attachment may be uploaded to more than one shared location (e.g. the attachment is uploaded to each recipient's configured shared location).

Flowing to operation 440, permissions for accessing the uploaded attachments are set. According to an embodiment, each attachment is set to read/write permission for each recipient of the message. The permissions may be set according to other criteria (e.g. the permissions may be set based on a security policy of an organization). For example, the security policy may set restrictions on accessing an attachment for a recipient that is not within the sender's organization (e.g. the sender includes a recipient that is located outside of the company). According to an embodiment, the security policy is predetermined such that permissions are set automatically without user interaction.

Moving to operation 450, the attachments within the message are replaced with links that may be used to access each of the uploaded attachments.

Transitioning to operation 460, the electronic message is sent to the recipients.

The process then flows to an end block and returns to processing other actions.

FIG. 5 shows a process for automatically downloading content that is associated with a received message that includes a link to an uploaded attachment.

After a start block, process 500 moves to operation 510, where the electronic message is received. The electronic message may be any electronic message that includes a link to an attachment that was uploaded to a shared location. According to an embodiment, the electronic messages are email messages. Other messages may also include links, such as SMS, MMS, Instant Messages, social network messages, and the like. The message may be received by a client based application and/or a Web based application.

Flowing to operation 520, any links to uploaded attachments within the electronic message are detected. A link may be associated with an uploaded attachment using different methods. For example, the link itself may contain information that indicates the content that the link addresses was automatically uploaded. According to an embodiment, the links are detected before the received message is viewed.

Moving to operation 530, the attachment may be automatically downloaded. According to an embodiment, the content is automatically downloaded and displayed within the attachment area of the electronic message before the user receiving the message views the message.

Transitioning to operation 540, the links to the content that is automatically downloaded are replaced with an attachment of the content.

Flowing to operation 550, the electronic message is displayed with the attachment with the electronic message. When a user views the message, the attachment may be opened.

The process then flows to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for automatically uploading an attachment to a shared location, comprising:
detecting an attachment to an electronic message that is addressed to a recipient;
automatically uploading the attachment to a shared location;
automatically setting permissions for the attachment at the shared location;
removing the attachment from the electronic message; and
inserting a link to the uploaded attachment; and
sending the electronic message.

2. The method of claim 1, further comprising determining the shared location based on a type of the attachment, wherein the shared location is selected from at least one of: a first shared location when the type of attachment is a picture; a second shared location when the type of attachment is a word processing document; and a third shared location when the type of attachment is a video.

3. The method of claim 1, wherein the shared location is selected based on one or more shared locations received from a user.

4. The method of claim 1, wherein automatically uploading the attachment to the shared location comprises determining when a send button is selected.

5. The method of claim 1, wherein removing the attachment from the electronic message comprises removing the attachment from the electronic message at a computing device other than a client computing device.

6. The method of claim 1, wherein setting the permissions for the attachment at the shared location such that the recipient is able to access the attachment comprises determining each recipient of the message and setting a default set of permissions for each of the recipients.

7. The method of claim 1, wherein setting the permissions for the attachment at the shared location such that the recipient is able to access the attachment comprises restricting permissions for a recipient that is determined to be outside of an organization of the sender.

8. The method of claim 1, wherein setting the permissions for the attachment at the shared location such that the recipient is able to access the attachment comprises denying access to a recipient that is determined to be outside of an organization of the sender.

9. The method of claim 1, further comprising automatically downloading the attachment before the electronic message is displayed by the recipient.

10. A computer-readable storage medium storing computer-executable instructions for automatically uploading an attachment to a shared location, comprising:
detecting an attachment to an electronic message that is addressed to a recipient;
automatically uploading the attachment to a shared location that is associated with an online service;
automatically setting permissions for the attachment at the shared location such that the recipient is able to access the attachment;
removing the attachment from the electronic message; and
inserting a link to the attachment at the shared location; and
sending the electronic message.

11. The computer-readable storage medium of claim 10, wherein setting the permissions for the attachment at the shared location such that the recipient is able to access the attachment comprises determining each recipient of the message and setting a default set of permissions for each of the recipients that are within an organization of a sender of the message.

12. The computer-readable storage medium of claim 10, wherein setting the permissions for the attachment at the shared location such that the recipient is able to access the attachment comprises determining each recipient of the message and restricting access to the attachment for each recipient that is outside of an organization of a sender of the message.

13. The computer-readable storage medium of claim 10, further comprising determining the shared location based on a type of the attachment.

14. The computer-readable storage medium of claim 10, wherein automatically uploading the attachment to the shared location that is associated with an online service is performed after a sender selects an option to send the message.

15. The computer-readable storage medium of claim 10, further comprising automatically downloading the attachment and removing the link from the electronic message before the electronic message is displayed by the recipient.

16. A system for automatically uploading an attachment to a shared location, comprising:
a network connection that is configured to connect to a network;
a processor, memory, and a computer-readable storage medium;
an operating environment stored on the computer-readable storage medium and executing on the processor;
a messaging application; and
a sharing manager operating in conjunction with the messaging application that is configured to perform actions comprising:
detecting an attachment to an electronic message that is addressed to a recipient;
automatically uploading the attachment to a shared location that is associated with an online service;
automatically setting permissions for the attachment at the shared location;
removing the attachment from the electronic message;
inserting a link to the attachment; and
sending the electronic message.

17. The system of claim 16, wherein automatically setting the permissions for the attachment at the shared location comprises determining when the recipient is outside of an organization of a send of the electronic message.

18. The system of claim 17, wherein automatically setting the permissions for the attachment at the shared location when the recipient is outside of the organization comprises restricting access to the attachment.

19. The system of claim 16, further comprising determining the shared location based on a type of the attachment that is one of: a picture; a word processing document; and a video.

20. The system of claim 16, further comprising automatically downloading the attachment and removing the link from the electronic message before the electronic message is displayed by the recipient.
